(19) United States
(12) Patent Application Publication
(10) Pub. No.: US 2004/0201486 A1
(43) Pub. Date: Oct. 14, 2004

(54) Solid state crossing controller and related methods

(76) Inventors: Thomas Knowles, Norco, CA (US); Rakesh Malhotra, Chino Hills, CA (US); Hung Pham, Rancho Cucamonga, CA (US); John Sharkey, Elgin, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/410,844

(22) Filed: Apr. 10, 2003

(51) Int. Cl. G08B 21/00

(52) U.S. Cl. 340/657; 246/20; 340/641

(57) ABSTRACT

A solid state crossing controller for a railroad crossing signal system with two independent outputs for controlling illumination of lamps in the signal system share a common neutral or return wire, with sensing of a common neutral or return line shared by the two independent outputs to determine any loss of the neutral line. When a failure has been detected in the neutral line, the controller modifies the voltages for the lamps in the signaling system for better illumination of the lamps during the failure condition, such as to the highest voltage available from a battery in the system. Upon detection of the failure in the neutral line, the controller may provide a call or message that there is a failure in the system that is in need of repair. If the failure in the neutral line is intermittent, the controller will resume normal operation after that train, has cleared the crossing. However, a call or message that a failure has occurred in the neutral line is provided. Tests for the failure will be repeated when the next train approaches the crossing. Related methods for determining whether a failure has occurred in the neutral line are also disclosed.

### FIELD OF THE INVENTION

The present invention relates to the field of railroad crossing signal systems located at highway-rail grade crossings, and more specifically, to such systems and methods that continue operation of the crossing controller when a neutral line fails.

### BACKGROUND OF THE INVENTION

Railroad crossing signal systems commonly utilize a crossing controller with two independent outputs. Each of the independent outputs provides energy for one-half of the lights of the signal system. If either of the two independent outputs fails, the other output will continue to supply energy to one-half of the lights such that the signal system continues to partially operate.

These two independent outputs of the crossing controller normally share a common neutral or return line, as described in Part 3.1.25 of the Manual of Recommended Practices for Communications and Signals published by the American Railway Engineering and Maintenance of Way (AREMA). As shown in this Manual, a gate tip light is connected across the independent output voltage sources. The flashing lights on the mast-mounted signal and on the gate arm are wired in series and a neutral line is connected to a flasher relay that shunts current around each light to provide flashing of the lights. Because of the legacy of this wiring practice, solid-state crossing controllers are generally required to interface with the same wiring practice. Loss of a common or neutral line may occur in a variety of circumstances, such as damage to the line itself, or due to a poor connection that may be caused by corrosion or the like.

There is therefore a need for a solid state crossing controller that can diagnose the loss of the neutral line and provide suitable indications of the need to repair or to restore the neutral line. There is also a need for a solid state controller with the capability to change from its normal operating conditions, when a loss of the neutral line is sensed, to provide improved operation of the signaling system during the loss of the neutral line.

### SUMMARY OF THE INVENTION

A general object of the present invention is to provide a solid state crossing controller that can sense or diagnose the loss of a neutral line. The loss of the neutral line may include a complete loss or a partial loss, such as a high impedance connection.

Another object of the present invention is to provide a solid state crossing controller that takes corrective action upon sensing a loss of the neutral line, such as increasing the voltage supplied to the lamps for increased illumination.

A further object of the present invention is to provide a solid state crossing controller that issues an error message upon detecting the loss of the neutral line.

This invention is generally directed to a solid state crossing controller for a railroad crossing signal system with two independent lamp drivers for controlling illumination of a plurality of lamps in the signal system and with voltage or current sensing of selected signals in the controller to determine any failure of the neutral line. When a failure of the neutral line has been sensed, the controller increases the voltages supplied by the lamp drivers to the lamps for better illumination of the lamps during the failure condition; such as to the highest voltage available from a battery in the system. The controller will also alternate the first and second lamp drivers in supplying power to the lamps. Upon sensing a failure in the neutral line, the controller may generate a call or message that the system is in need of repair. Sensing of the failure in the neutral line may be accomplished, for example, by sensing the voltage level at the second lamp driver when the first lamp driver is supplying operating power to the lamps, or by sensing the current conducted through the second lamp driver when the first lamp driver is supplying operating power.

If the failure in the neutral line is intermittent, the controller resumes normal operation after the failure in the neutral line ceases. However, a call or message that a failure has occurred in the neutral line is generated and remains displayed for the user.

Related methods of determining whether a failure has occurred in the neutral line of the solid state crossing controller include sensing the operative condition of the conductive state of one of the lamp drivers to determine if a failure has occurred, generating a failure signal in response to determining that a failure has occurred and supplying the failure signal to a microprocessor. The microprocessor may cause the lamp drivers to increase the voltage of the operating power supplied to the lamps for greater brightness of the lamps, alternate the first and second lamp drivers in supplying power to the lamps, and generate an alert signal to indicate that the neutral line has a failure. The microprocessor will also return the controller to its normal operation upon cessation of the failure signal.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the drawing figures in which like reference numerals identify like elements, and in which:

FIG. 1 is an electrical circuit diagram of a prior art crossing controller in which the flashing lamps are connected to a common neutral line;

FIG. 2 is an electrical circuit diagram of a crossing controller in accordance with the present invention for determining when the neutral line is open by sensing voltages or currents at points in the circuit, including a microprocessor to analyze the sensed voltages or currents, and to change the power supplied to the signaling lamps upon detecting an open neutral line condition;

FIG. 3 is a flow chart of the steps that may be employed by the microprocessor in FIG. 2 in accordance with voltage sensing techniques to sense for a failure of the neutral line; and

FIG. 4 is a flow chart of the steps that may be employed by the microprocessor in FIG. 2 in accordance with alternative current sensing techniques to sense for a failure in the neutral line.

### DESCRIPTION OF THE PREFERRED EMBODIMENTS

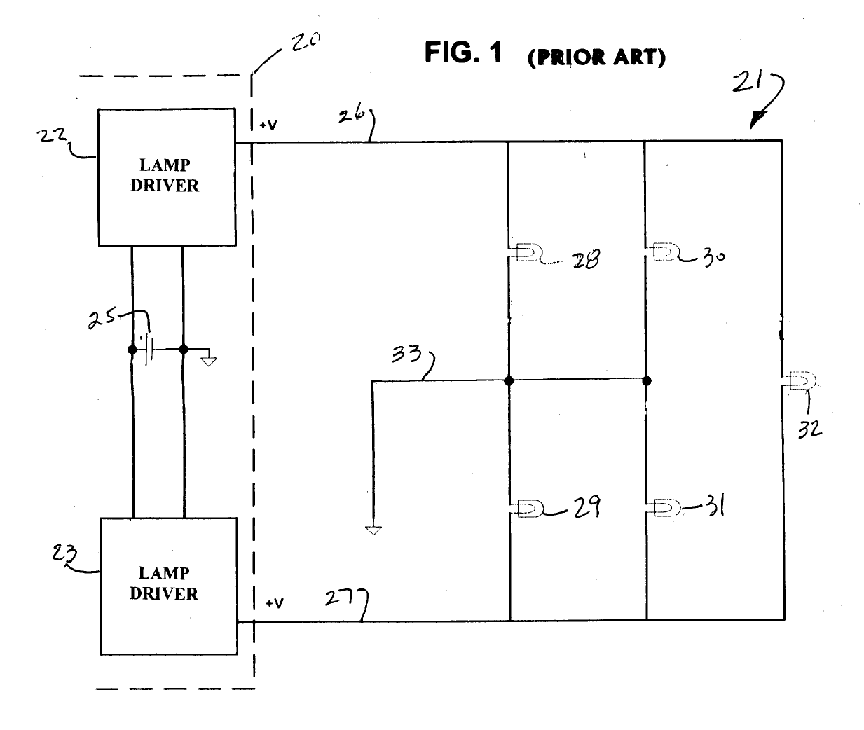

A prior art solid state controller 20 for a railroad crossing signal system, generally designated 21, is illustrated in FIG. 1. It is assumed that controller 20 is a solid state device instead of a relay driven device. Solid state controller 20 includes a pair of lamp drivers 22 and 23 to apply a portion of the potential of a battery 25 on respective output lines 26 and 27 to a plurality of lamps 28-32 in the signal system 21.

Lamps 28 and 29 may be disposed on a wayside signaling device, lamps 30 and 31 may be disposed on gate arms and lamp 32 may be disposed at or near the tip or end of the gate arm of the signaling system 21. Lamp drivers 22 and 23 of controller 20 alternate in the application of the potential of battery 25 to their respective output lines 26 and 27 to source sufficient current to drive the lamps 28-32. Lamps 28-32 operate in two different modes. Lamps disposed along side of the road, such as lamps 28 and 29 that may be disposed on a wayside signaling device, and lamps 30 and 31 that may be disposed along the middle of a gate arm that is used to block traffic, operate in a flashing mode. On the other hand, lamp 32 located on or near the tip of the gate arm appears to be continuously illuminated.

Lamp drivers 22 and 23 supply current from battery 25 when in the “on” mode and sink current from the tip lamp 32 when in the “off” mode. Lamp drivers 22 and 23 typically operate in a flashing mode of about 35 to 65 flashes per minute, with about a 48 percent duty cycle. That is, lamp drivers 22 and 23 are each in the “on” mode for 48 percent of the time. Lamp driver 23 is 180 degrees out of phase from lamp driver 22. Thus, when lamp driver 22 is supplying current, flashing lamps 28 and 30 are illuminated, and lamp driver 23 is sinking current from tip lamp 32. During the opposite phase of the flashing cycle, lamp driver 23 will be supplying current to flashing lamps 29 and 31, and lamp driver 22 will be sinking current from tip lamp 32. Thus, lamps 28 and 30 flash at opposite times in the flashing cycle to lamps 29 and 31. It will be appreciated that current supplied by lamp driver 22 or 23 to respective lamps 28 and 30, or to lamps 29 and 31, complete a path to common through a neutral line 33.

Since it is desired that tip lamp 32 appear to be constantly on, tip lamp 32 is connected across the output lines 26 and 27 of lamp drivers 22 and 23, instead of to the neutral line 33. If lamp driver 22 is in the “on” mode, current flows from driver 22 and is sunk by driver 23. If lamp driver 23 is in the “on” mode, current flows in the opposite direction through tip lamp 32 and is sunk by driver 22. Tip lamp 32 is thus driven at a 96 percent or better duty cycle. Lamp 32 appears to be constantly illuminated because the 2 percent of time when tip lamp 32 is not receiving current between the switching of lamp drivers 22 and 23 during each half of the cycle may be insufficient time for the filament in lamp 32 to substantially reduce its illumination. Even if the filament of tip lamp 32 substantially decreases its illumination, the time is sufficiently short that any decrease in illumination may not be humanly perceptible.

One type of failure condition occurs when neutral line 33 is broken or otherwise becomes a high impedance connection to common. When the signaling system is activated with this condition, the current supplied to lamps 28-31 is no longer conducted to common, which results in current through these normally flashing lamps being conducted to common by the opposite lamp driver 22 or 23, in a manner similar to that of the tip lamp 32. This means that lamps 28-31 remain on continuously like tip lamp 32. However, lamps 28-31 now operate at substantially reduced brightness since the voltage supplied by lamp drivers 22 and 23 is now split across two lamps, such as across the lamp pair 28 and 29, and across the lamp pair 30 and 31. This reduced brightness of normally flashing lamps 28-31 presents a hazard to the motoring public, particular during the daylight hours when it becomes more difficult to see the dimmer lamps. This hazard is also compounded by the fact that the motoring public expects to see lights 28-31 in a flashing mode, which will not occur if the neutral line 33 is open.

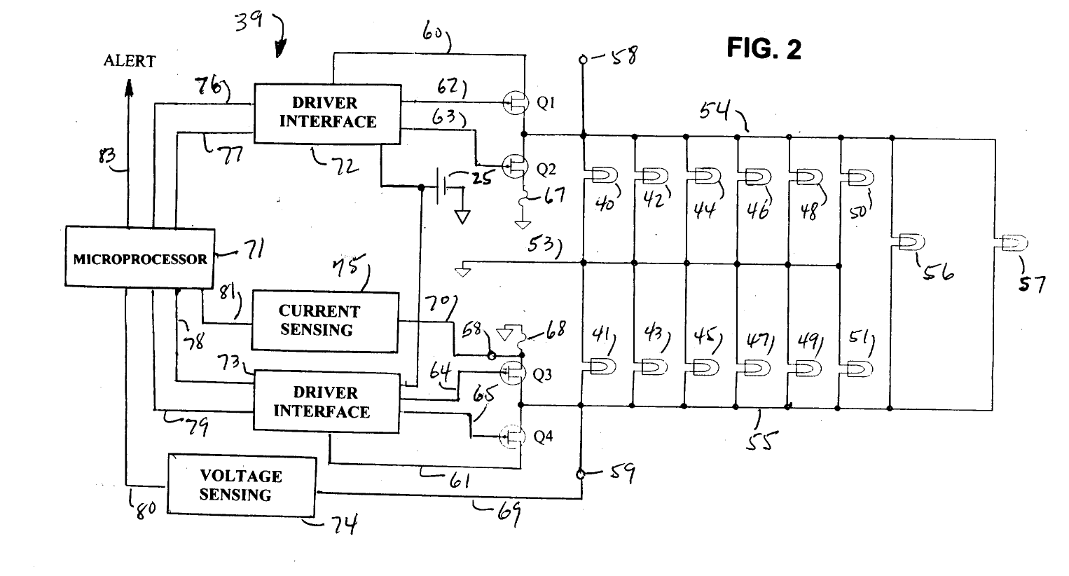

A preferred implementation for a crossing controller 39 in accordance with the present invention is shown in FIG. 2. In this example of practicing the present invention, lamps 40 and 41 may be on a first gate at the crossing, lamps 42 and 43 may be on a second gate, lamps 44 and 45 may be on a first flasher, lamps 46 and 47 may be on a second flasher, lamps 48 and 49 may also be on the first flasher, lamps 50 and 51 may also be on the second flasher, lamp 56 may be a tip lamp on the first gate and lamp 57 may be a tip lamp on the second gate. Lamps 40-51 all have one terminal referenced to common by a neutral line 53.

A first lamp driver consists of driver interface circuitry 72 that controls the conductive state of a pair of field effect transistors (FETs) Q1 and Q2, which are connected in series between a source of voltage supplied on a line 60 and common. In a similar manner, driver interface circuitry 73 controls the conductive state of another pair of FETs Q3 and Q4, which are connected in series between a source of voltage supplied on a line 61 and common. A fuse 67 may be in series between FET Q2 and common, and a fuse 68 may be in series between FET Q3 and common. Fuses 67 and 68 may be of the polyfuse type.

A microprocessor 71 controls the driver interfaces 72 and 73, which in turn control the conductive state of FETs Q1-Q4. In normal operation, during a first portion of the cycle, FET Q1 is turned on to supply a voltage potential on line 60 through Q1 to line 54 to supply operating current to gate and flasher lamps 40, 42, 44, 46, 48 and 50 and to tip lamps 56 and 57. Current through lamps 40, 42, 44, 46, 48 and 50 will flow to common through neutral line 53. At the same time that FET Q1 is turned on, driver interface 73 turns on FET Q3 to sink current through tip lamps 56 and 57 to common. The voltage potential supplied on line 60 is preferably a portion of the available voltage from a battery 25 or other source of potential.

Before the second portion of the cycle, FETs Q1 and Q3 are turned off. During the second portion of the cycle, microprocessor 71 causes driver interface 73 to turn on FET Q4 to supply a voltage potential on line 61 to line 55 to supply operating current to gate and flasher lamps 41, 43, 45, 47, 49 and 51 and to tip lamps 56 and 57. At the same time that FET Q4 is turned on, driver interface 72 turns on FET Q2 to sink current through tip lamps 56 and 57 to common. However, current supplied by FET Q4 to lamps 41, 43, 45, 47, 49 and 51 flows to common through the neutral line 53. The voltage potential supplied on line 61 is preferably a portion of the available voltage from battery 25 or other source of potential.

Thus, in normal operation, half of the flashing lamps 40-51 are illuminated when FETs Q1 and Q3 are turned on during the first portion of the cycle, and the other half of the lamps 40-51 are illuminated when FETs Q4 and Q2 are turned on during the second portion of the cycle, to provide the desired flashing effects. Tip lamps 56 and 57 are illuminated in both portions of the cycle to give the appearance of continuous illumination.

In accordance with the present invention, the crossing controller 39 is also capable of diagnosing any failure in the ability of the neutral line 53 to provide a current path to common. In the embodiment shown in FIG. 2, FET Q1 is initially turned on, without FET Q3 turned on, for a short time such as about 0.02 seconds. If the neutral line 53 provides a good connection to common, only a portion of the potential supplied by FET Q1 from line 60 to line 54 will appear at the opposite FET Q3 on line 55. This is because current through tip lamps 56 and 57 will be conducted through lamps 41, 43, 45, 47, 49 and 51 and through neutral line 53 to common. However, if neutral line 53 is broken and with FET Q3 in the off mode, current supplied by FET Q1 has no path to flow to common. Thus, the potential across FET Q3 and on line 55 will be at the full potential of line 54.

A voltage sensing circuit 74 is connected via a line 69 to a node 59 on line 55 to sense the voltage on line 55. Voltage sensing circuit 74 can discriminate between the lower potential on line 55 when the neutral line 53 is functioning properly and the full potential on line 53 when neutral line 53 is open. Microprocessor 71 monitors voltage sensing circuit 74 via line 80 during the momentary test when FET Q1 is conductive and FET Q3 is nonconductive to determine if neutral line 53 is open. If so, voltage sensing circuit 74 will provide a failure signal on line 80 to the microprocessor.

Alternatively, a current sensing technique may be used to determine any failure in the neutral line 53. In the example of FIG. 2, it is assumed that fuse 68 has a small ohmic value that will create a small potential at node 58 when current is conducted through FET Q3 when both FETs Q1 and Q3 are in the on mode. Otherwise, a resistor of low ohmic value may be placed in series with fuse 68 to provide a small voltage drop when FET Q3 is conductive. Various types of current sensing devices may alternatively be placed in series with fuse 68, if desired. If neutral line 53 is in good condition, the only current conducted through FET Q3 will be from tip lamps 56 and 57, which may be a couple of amperes. However, if neutral line 53 is open, current through lamps 40, 42, 44, 46, 48 and 50 will now flow through lamp pairs 40-41, 42-43, and so forth, to line 55 to be conducted to common through FET Q3. Thus, the current conducted through FET Q3 upon failure of neutral line 53 will increase, such as to several amperes.

A current sensing circuit 75 is connected to node 58 via line 70 to monitor the small potential across fuse 68. If any failure of neutral line 53 causes a corresponding increase in potential at node 58, current sensing circuit 75 will send a failure signal to microprocessor 71 on line 81. Microprocessor 71 may then cause driver interfaces 72 and 73 to apply the maximum available potential on respective lines 60 and 61 for brighter illumination of lamps 40-51. It will be appreciated that when neutral line 53 fails, lamps 40-51 receive only one-half of the available potential from lines 60 or 61 because lamp pairs 40-41, 42-43, and so forth, are then effectively connected in series between FETs Q1 and Q3. Lamps 40-51 will then operate at lower illumination levels. Increasing of the available potential on lines 60 and 61 during a neutral line failure thereby helps counteract this decreased illumination from lamps 40-51. When neutral line 53 fails, it is also desirable to have all of lamps 40-51 simultaneously flash, rather than being continuously on. To this end, microprocessor 71 may periodically activating FETs Q1 and Q3 and FETs Q2 and Q4, but with a delay of about 0.5 seconds between each energization of the lamps 40-51 to simulate a flashing effect. That is, lamps 40-51 will all be illuminated for about 0.5 seconds, followed by a 0.5 second period of no illumination, and so forth. In this situation, the tip lamps 56 and 57 will also flash due to the 0.5 second periods of non-illumination. After a failure in neutral line 53 is detected by voltage sensing 74 or current sensing 75, microprocessor 71 provides a signal on line 83 such as to maintenance personnel, or the like, to indicate that a failure has occurred. If the neutral line failure is intermittent or otherwise ceases, microprocessor 71 will resume normal control of various lamps, but the alert signal on line 83 will continue to be sent to the maintenance personnel to alert that a malfunction occurred in the neutral line. The error or alert signal on line 83 may be a local alert, a remote alert, or both.

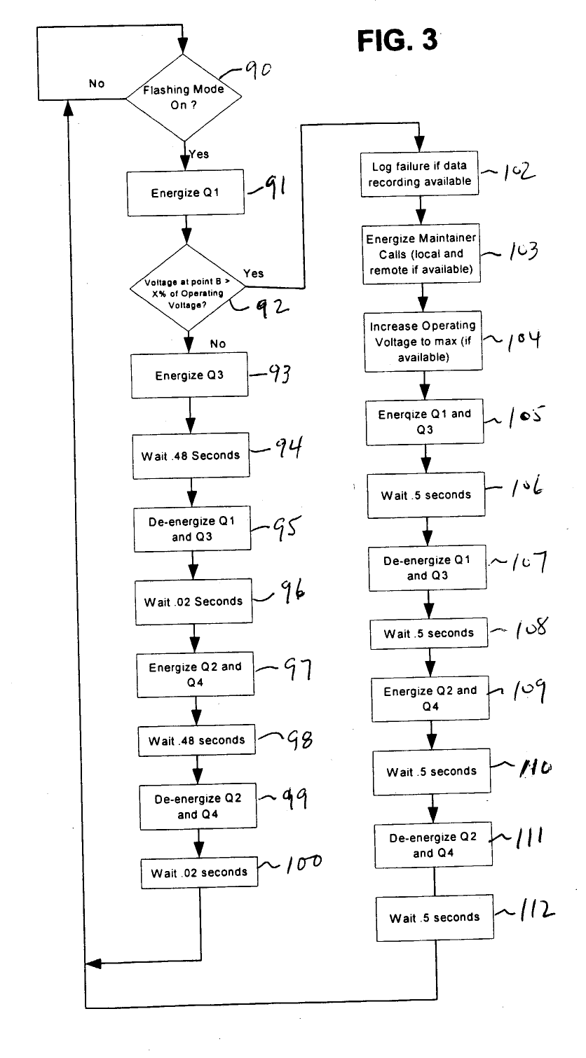

FIG. 3 illustrates various steps that may be used by microprocessor 71 in accordance with the previously described voltage sensing technique for detecting whether the neutral line 53 has failed. In the first decision block 90, the crossing controller decides whether it should be in the flashing mode, such as when a train is near the crossing. If so, FET Q1 is energized in block 91, but FET Q3 is not yet energized. The voltage level, such as at node 59 in FIG. 2, is then checked to see if it exceeds a certain threshold or a certain percent of the operating voltage. If not, the neutral line is determined to be operative and FET Q3 is energized as indicated in block 93 to provide a conductive path for tip lamps 56 and 57 to common. Microprocessor 71 then keeps FETs Q1 and Q3 conductive for about 0.48 seconds before turning FETs Q1 and Q3 off as shown in blocks 94 and 95. After a wait of about 0.02 seconds in block 96, FETs Q2 and Q4 are activated in block 97 to energize selected lamps as previously discussed with reference to FIG. 2. After about 0.48 seconds as shown in block 98, FETs Q2 and Q4 are turned off in block 99. After a wait of about 0.02 seconds in block 100, the process returns to block 90.

Returning to decision block 92, if it is determined that the voltage at node 59 is greater than the threshold or greater than a certain percent of the operating voltage, then there is a failure or break in the neutral line and the process goes to block 102. The failure may be logged if data recording is available, at block 102, and maintainer calls are sent to both local and remote locations to notify of the need to repair the neutral line, at block 103. As previously discussed with reference to FIG. 2, the flashing lamps 40-51 will not receive full operating voltage when neutral line 53 fails. Thus, microprocessor 71 now increases the operating voltage to the maximum level, if additional operating voltage is available, as shown in block 104. FETs Q1 and Q3 are then activated to energize the lamps, block 105, for about 0.5 seconds, block 106, before being deactivated in block 107. After about a 0.5 second wait, block 108, FETs Q2 and Q4 are activated to again energize the lamps for about 0.5 seconds, block 110, before being deactivated at block 111. After a 0.5 second wait, the process returns to block 90. Thus, whenever neutral line 53 is faulty, the controller will control the lamps in accordance with blocks 102-112. Note that in this mode, all of the lamps 40-51 and tip lamps 56 and 57 are periodically activated for about 0.5 seconds, followed by deactivation for about 0.5 seconds. This provides a flashing effect despite the faulty neutral line.

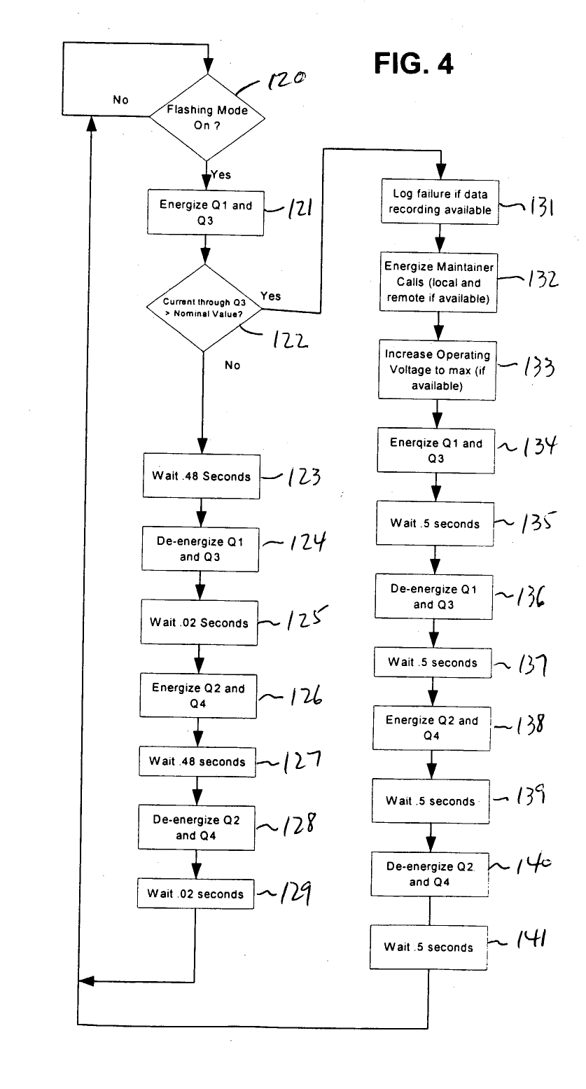

FIG. 4 illustrates various steps that may be used by microprocessor 71 in accordance with the previously described current sensing technique for detecting if the neutral line 53 has failed. In the first decision block 121, the crossing controller decides whether it should be in the flashing mode. If so, FETs Q1 and Q3 are energized as shown in block 121. The current conducted through FET Q3 is then checked in block 121 to see if it exceeds a nominal value. As previously discussed, this may be accomplished by current sensing circuitry 75 which monitors the potential at node 58 in FIG. 2. If the current conduced by FET Q3 does not exceed a nominal value, the neutral line is determined to be operative. Microprocessor 71 then keeps FETs Q1 and Q3 conductive for about 0.48 seconds before turning FETs Q1 and Q3 off as shown in blocks 123 and 124. After a wait of about 0.02 seconds in block 125, FETs Q2 and Q4 are activated in block 126 to energize selected lamps as previously discussed with reference to FIG. 2. After about 0.48 seconds as shown in block 127, FETs Q2 and Q4 are turned off in block 128. After a wait of about 0.02 seconds in block 129, the process returns to block 120.

Returning to decision block 122 in FIG. 4, if it is determined that the current at node 58 is greater than the nominal value, then it is assumed that a failure or break has occurred in the neutral line and the process goes to block 131. The failure may be logged if data recording is available, at block 131, and maintainer calls are sent to both local and remote locations to notify of the need to repair the neutral line, at block 132. As previously discussed, the flashing lamps 40-51 will not receive full operating voltage when neutral line 53 fails. Thus, microprocessor 71 now increases the operating voltage to the maximum level, if additional operating voltage is available, as shown in block 133. FETs Q1 and Q3 are then activated to energize the lamps, block 134, for about 0.5 seconds, block 135, before being deactivated, block 136. After about a 0.5 second wait, block 137, FETs Q2 and Q4 are activated, block 138, to again energize the lamps for about 0.5 seconds, block 139, before being deactivated at block 140. After a 0.5 second wait at block 141, the process returns to block 120. Thus, whenever neutral line 53 is faulty and the current sensing technique of FIG. 4 is used, the controller will control the lamps in accordance with blocks 131-141. In this mode, all of the lamps 40-51 and tip lamps 56 and 57 are periodically activated for about 0.5 seconds, followed by deactivation for about 0.5 seconds. This provides a flashing effect despite the faulty neutral line.

While particular embodiments of the invention have been shown and described, it will be obvious to those skilled in the art that changes and modifications may be made therein without departing from the invention in its broader aspects.

1. A solid state crossing controller for a railroad crossing signal system comprising:
a pair of lamp drivers including a first lamp driver with an output and a second lamp driver with an output;
a first plurality of signaling lamps coupled to the output of said first lamp driver for receiving operating power therefrom;
a second plurality of signaling lamps coupled to the output of said second lamp driver for receiving operating power therefrom;
a neutral line that is referenced to common, said neutral line also coupled to the first plurality of signaling lamps and to the second plurality of signaling lamps to provide a conductive path for operating power from the output of the first lamp driver through the first plurality of signaling lamps to common and to provide a conductive path for operating power from the output of the second lamp driver through the second plurality of signaling lamps to common, and
sensing circuitry for detecting a failure condition in the neutral line and for generating a failure signal in response to detecting a failure condition in the neutral line.

2. The solid state crossing controller in accordance with claim 1 further comprising:
a microprocessor, said microprocessor coupled to the first and second lamp drivers to control the conductive state of said lamp drivers, and said microprocessor also coupled to the sensing circuitry to receive said failure signal.

3. The solid state crossing controller in accordance with claim 2 wherein said microprocessor causes the first and second lamp drivers to increase the voltage of the operating power supplied to the first and second pluralities of signaling lamps when the microprocessor receives the failure signal from said sensing circuitry.

4. The solid state crossing controller in accordance with claim 2 wherein said microprocessor alternates activation of the first and second lamp drivers in supplying operating power to the first and second pluralities of signaling lamps during the neutral line failure.

5. The solid state crossing controller in accordance with claim 4 wherein said microprocessor interposes a period of delay between the alternate activation of the first and second lamp drivers such that the first and second pluralities of signaling lamps are not illuminated during the period of delay to provide a flashing effect of the first and second pluralities of signaling lamps during the neutral line failure.

6. The solid state crossing controller in accordance with claim 4 wherein the crossing controller returns to its normal operating condition upon cessation of the failure in the neutral line.

7. The solid state crossing controller in accordance with claim 2 wherein said microprocessor provides an alert signal, when said microprocessor receives the failure signal from said sensing circuitry, to indicate that a failure in the neutral line has occurred.

8. The solid state crossing controller in accordance with claim 1 wherein the detection circuitry comprises voltage sensing circuitry for sensing the voltage at the output of the second lamp driver when the first lamp driver is supplying operating power to the first plurality of signaling lamps.

9. The solid state crossing controller in accordance with claim 1 wherein the detection circuitry comprises current sensing circuitry for sensing the current conducted through the second lamp driver when the first lamp driver is supplying operating power to the first plurality of signaling lamps.

10. The solid state crossing controller in accordance with claim 1 further comprising one or more tip lamps connected between the output of the first lamp driver and the output of the second lamp driver.

11. A method of determining whether a failure has occurred in a neutral line of a solid state crossing controller, the crossing controller comprising a pair of lamp drivers including a first lamp driver with an output and a second lamp driver with an output; a first plurality of signaling lamps coupled to the output of said first lamp driver for receiving operating power therefrom; a second plurality of signaling lamps coupled to the output of said second lamp driver for receiving operating power therefrom; a neutral line that is referenced to common, said neutral line also coupled to the first plurality of signaling lamps and to the second plurality of signaling lamps to provide a conductive path for operating power from the output of the first lamp driver through the first plurality of signaling lamps to common and to provide a conductive path for operating power from the output of the second lamp driver through the second plurality of signaling lamps to common, and a microprocessor, said microprocessor coupled to the first and second lamp drivers to control the conductive state of said lamp drivers; said method comprising the steps of:
sensing the operative condition of one of said line drivers to determine if a failure has occurred in the neutral line, and
generating a failure signal in response to determining that a failure has occurred in the neutral line.

12. The method of determining whether a failure has occurred in a neutral line of a solid state crossing controller in accordance with claim 11, further including the additional steps of:
receiving the failure signal at the microprocessor, and
increasing the voltage of the operating power supplied to the first and second pluralities of signaling lamps in response to receipt of the failure signal.

13. The method of determining whether a failure has occurred in a neutral line of a solid state crossing controller in accordance with claim 11, further including the additional steps of:
receiving the failure signal at the microprocessor, and
alternating the first and second lamp drivers in supplying operating power to the first and second pluralities of signaling lamps during the neutral line failure.

14. The method of determining whether a failure has occurred in a neutral line of a solid state crossing controller in accordance with claim 11, further including the additional step of:
returning to normal operation of the crossing controller upon cessation of the failure in the neutral line.

15. The method of determining whether a failure has occurred in a neutral line of a solid state crossing controller in accordance with claim 11, further including the additional step of:
providing an alert signal upon receipt of the failure signal.

16. The method of determining whether a failure has occurred in a neutral line of a solid state crossing controller in accordance with claim 11, wherein the step of sensing the operative condition of one of said line drivers to determine if a failure has occurred in the neutral line includes the step of sensing the voltage level at the output of the second lamp driver when the first lamp driver is supplying operating power to the first plurality of signaling lamps.

17. The method of determining whether a failure has occurred in a neutral line of a solid state crossing controller in accordance with claim 11, wherein the step of sensing the operative condition of one of said line drivers to determine if a failure has occurred in the neutral line includes the step of sensing the current conducted through the second lamp driver when the first lamp driver is supplying operating power to the first plurality of signaling lamps.
